(19) United States
(12) Patent Application Publication
(10) Pub. No.: US 2015/0195624 A1
(43) Pub. Date: Jul. 9, 2015

(54) Media-Related Trends

(71) Applicant: Richard C. Gossweiler, III, Sunnyvale, CA (US)

(72) Inventor: Richard C. Gossweiler, III, Sunnyvale, CA (US)

(73) Assignee: Google Inc.

(21) Appl. No.: 12/938,834

(22) Filed: Nov. 3, 2010

(51) Int. Cl. H04N 21/482; H04N 5/445; H04N 21/475; H04N 21/431; H04N 21/462; H04N 21/466; H04N 21/84; H04N 21/262; G06F 17/30; H04N 21/4782

(52) U.S. Cl. CPC H04N 21/4826; H04N 5/44543; H04N 21/4756; H04N 21/4782; H04N 21/4821; H04N 21/4828; H04N 21/4622; H04N 21/4667; H04N 21/84; H04N 21/26241; H04N 21/4312; H04N 2005/44556; H04N 2005/44578

(57) ABSTRACT

A computer-implemented method, including receiving, by a computer system, a request for a display of media-related information; obtaining, by the computer system, information indicative of popularity for a plurality of media programs responsive to the received request; and displaying, by the computer system, the media programs in an electronic program guide with a display of popularity of the media programs.

### FIELD

This disclosure relates to electronic program guides and presentation of media-related information.

### BACKGROUND

People really like watching television. Whether for education, entertainment, or escape, many people retire each evening to some well-earned television viewing. Often, however, people may watch programs that are not good at all or at least are not good for them, such as because they have limited ability to identify the best available television programming. Electronic program guides can help viewers identify programs, but often only if a particular viewer already knows the name of the show that he or she wants to watch, or is willing to scan through all available programs (i.e., to channel surf).

### SUMMARY

This document describes systems and techniques by which trend information for media programs, such as television programs and movies, may be determined, and may be presented to a user, such as a person reviewing an electronic program guide. The trend information or data may be obtained, for example, by tracking search term and/or click data for particular terms, such as program titles, genres, actors' names, or certain programs, and for other programs that are co-related in some manner to the initially-identified programs. For example, a system like GOOGLE TRENDS may be accessed using certain media-related terms, and trend indicators may be extracted from such data for particular programs or terms associated with particular programs. Popularity data may also be obtained for programs. Users may then be shown results or recommendations ranked or organized according to trend information, and in some circumstances, additionally by popularity information. For example, a program with low popularity that is trending upward may be given an elevated importance when displayed to a user, under the assumption that it is very relevant to the user even though the general public has not yet “found” the program.

In one implementation, a computer-implemented method is disclosed. The method comprises receiving, by a computer system, a request for a display of media-related information; obtaining, by the computer system, information indicative of popularity for a plurality of media programs responsive to the received request; and displaying, by the computer system, the media programs in an electronic program guide with a display of popularity of the media programs. The request can relate to a predetermined time period over which the media programs are available for viewing. Also, the information indicative of popularity can comprise trend data that represent trends over time of popularity of one or more media programs, internet search activity data or news story information, or media ratings data. The electronic program guide can comprise a two dimensional programming grid, and the method can further comprise displaying popularity of the media programs through background representations in cells of the programming grid.

In some aspects, the method further comprises sorting channels in the electronic program guide in order of popularity. The request for the display of media-related information can also be generated by a selection of a hyperlink representing an episode of a media program. In addition, the method can also include receiving a search request, providing media-related search results in response to the search request, and receiving the request for the display of media-related information by selection of a portion of the search results.

In another implementation, a computer-implemented system is disclosed that comprises memory storing data relating to popularity of one or more media programs; an interface configured to receive media-related requests and match the requests to the data relating to popularity of one or more media programs; and a programming guide builder executable on a computer system to generate code for constructing a programming guide containing programs response to the media related requests and displaying popularity indications for the programs in the guide. The the data relating to popularity can include trend data for the programs that indicates trends over time in popularity of the programs. Also, the received media-related requests can relate to a predetermined time period over which the media programs are available for viewing. The data can also be correlated to information indicative of popularity that comprises trend data that represent trends over time of popularity of one or more media programs. Moreover, data can be correlated to information indicative of popularity that comprises internet search activity data or news story information, or that that comprises media ratings data. In addition, the program guide builder can be programmed to sort channels in the electronic program guide in order of popularity.

In another implementation, one or more tangible non-transitory computer-readable storage media are disclosed that store instructions. When the instructions are executed that perform actions that comprise receiving, by a computer system, a request for a display of media-related information; obtaining, by the computer system, information indicative of popularity for a plurality of media programs responsive to the received request; and displaying, by the computer system, the media programs in an electronic program guide with a display of popularity of the media programs.

The details of one or more embodiments are set forth in the accompanying drawings and the description below. Other features, objects, and advantages will be apparent from the description and drawings, and from the claims.

### DESCRIPTION OF DRAWINGS

FIG. 1A is an example screen shot showing a program guide displaying popularity information.

FIG. 1B is an example screen shot showing a program guide arranged using popularity information.

FIG. 2 shows a graph showing trends between two media programs of a general correlation between two forms of audience preference data over time.

FIG. 3 is a flow chart of a process for identifying trends in media information.

FIG. 4 is a flow chart of a process for associating media programs with popularity data.

FIG. 5 is schematic diagram of a system for providing media-related popularity information.

FIG. 6 is a flow chart of a process for computing popularity data for multiple media programs and multiple time periods.

FIG. 7 shows an example of a computer device and a mobile computer device that can be used to implement the techniques described here.

Like reference symbols in the various drawings indicate like elements.

### DETAILED DESCRIPTION

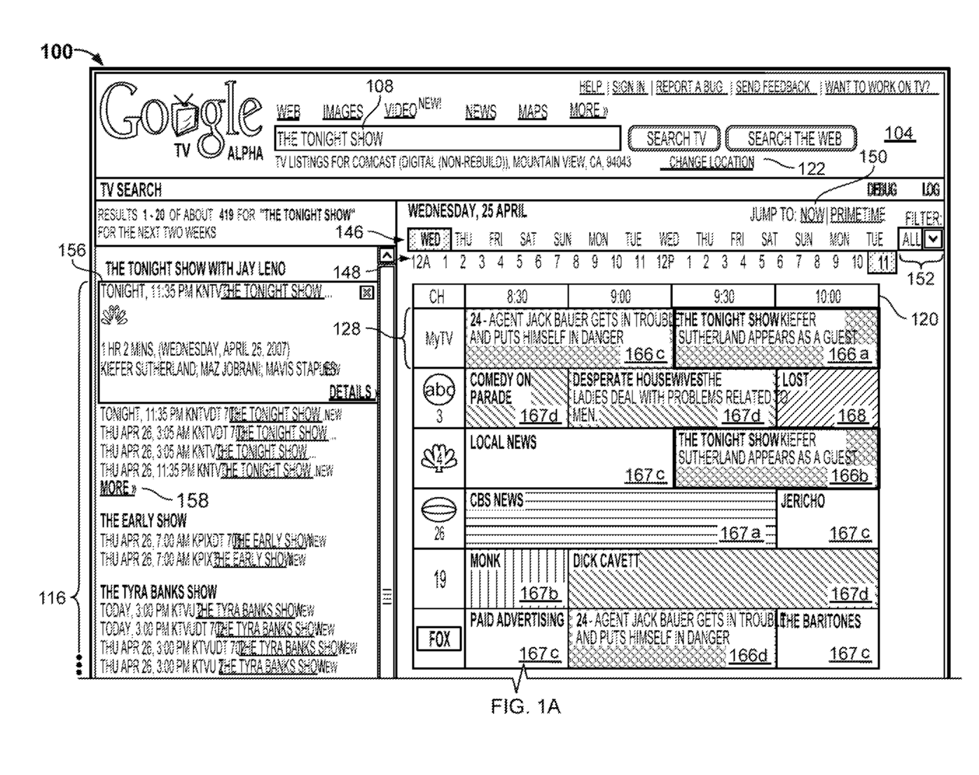

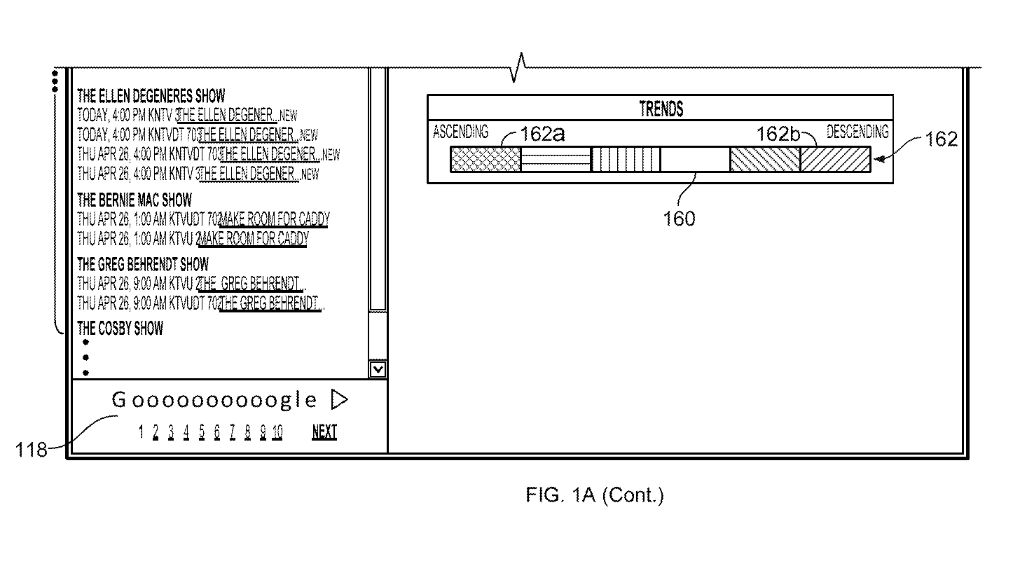

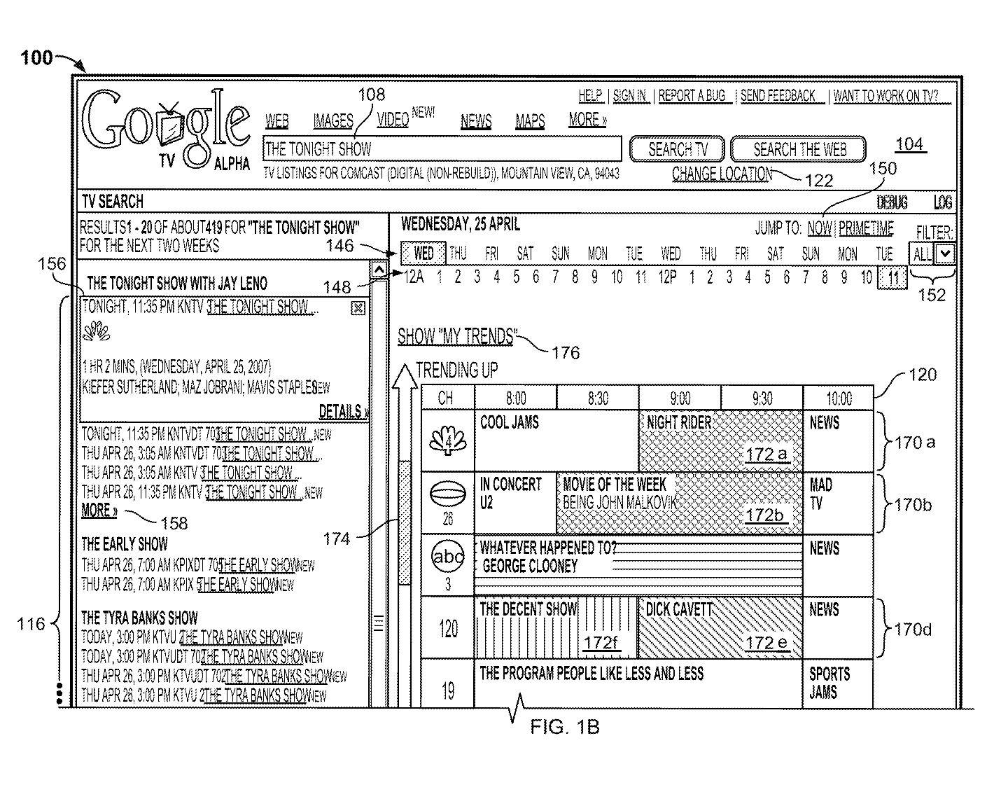

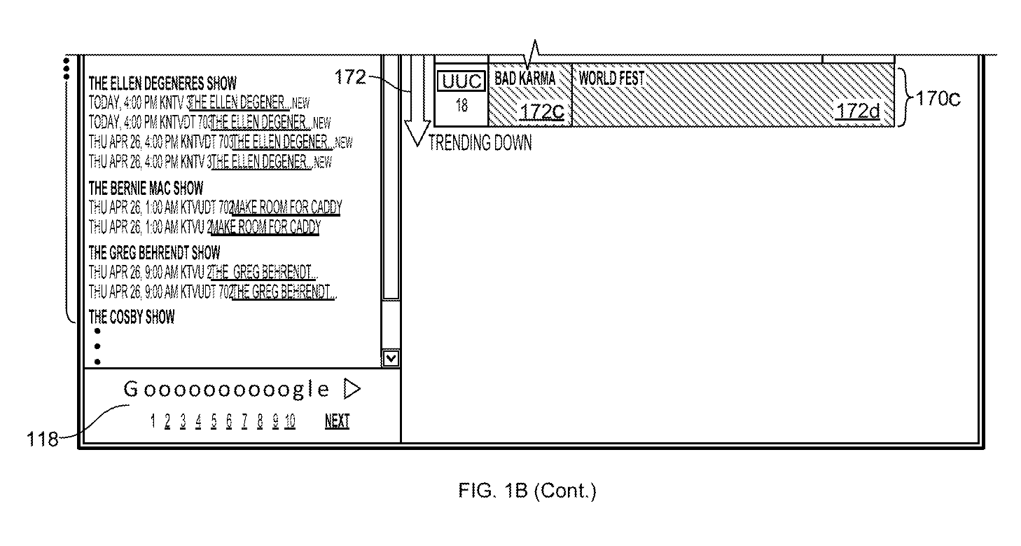

FIG. 1A is an example screen 104 in a system 100 showing a program guide displaying popularity information. This particular screen 104 represents one mechanism by which to display popularity information associated with media programs such as television programs, movies, books, podcasts, and the like. Other mechanisms are also contemplated, though the illustrated mechanism is provided here to add clarity to an understanding of the techniques described below.

In particular, the pictured program guide schedule grid 120 includes various types of hatching on each of its cells. The hatching can provide the user (e.g., the user who is viewing the program guide grid) a visual indicator of the relative popularity of each show. The popularity may be a static popularity, a dynamic popularity, or some combination of popularities. A static popularity may represent, for example, the number of current viewers of the program, news story information that is related to the program, or user click activity related to the program. Dynamic popularity may represent trends, such as trends indicating how popular (or unpopular) a particular program is becoming over time, or how much advertisers are willing to pay for an ad shown during the program. When such dynamic and static popularities are used together to form trends, for example, even a program having a low current static popularity would get a better showing if its dynamic popularity is increasing.

Hatching of episode cells is one example mechanism for indicating show popularity and/or trends, such as in a program guide grid. Other mechanisms may include, for example, color shading of cells (e.g., red-colored cells for hot shows, blue for “cold” or unpopular shows, etc.), motion (e.g., flashing or animation for popular shows), etc. Combinations of hatching, color, and motion, etc. may also be used. In one example, the popularity of shows may be shown as a “heat map,” where, for example, “hot” shows are shown in red, “cold” shows are shown in blue, and shows in between are shown in other such colors.

The program guide schedule grid 120 may be generated, for example, while a user is watching television. When the electronic program guide is displayed, popularity and trend information may also be displayed, such as in the form of hatching. The particular shows displayed in the grid may be based on a query that the user has entered, such as to search for TV programs related to the user's search terms. Although many examples related to television schedule grids are used herein to explain the generation and use of media programming popularity and trend information, other visualizations of the data may exist. In addition, non-visual implementations may also exist, such as, for example, the use of popularity/trend data to dynamically affect the costs of advertisements shown with the media programming.

The basis for popularity/trend information for particular shows may change over time. For example, popularity/trends for a new show may be based initially on audience measurement ratings information or other such information that is available early in a program's life. As the show becomes more established over time, the basis of the popularity/trends may further include search data or click-through data from a public search engine.

For example, popularity/trends may be based on input received on the Internet from several users who may have watched the show, visited web sites related to the show, provided user feedback related to the show, etc. Such data indicates user interests, so that popularity/trends displayed to one user may be based on other users who have provided similar search terms for general topics or for media-related topics, and may be generated from other media-related activity by those other users. Similarly, users may be related in other ways, such as by commonality in user profiles that have been completed by the users, or by connections formed between users in a social networking web site. As a simplified example, if several requesting users have entered searches for “Jaws,” “Orca,” and similar terms, the system 100 may score a higher popularity for those types of shows. Similarly, if popularities of such shows increase (or decrease) over time, a system may score the associated trends as increasing (or decreasing). Likewise, other searches entered by such users may increase the popularity of media programs relating to those other searches, for the other members of the group that entered terms like “Jaws” and “Orca.” Such co-dependency of information between two users may allow a system to infer that the users share certain interests, so that the system may then extrapolate observations of other activity by the users as involving an interest by other such users.

As also noted, user profiles may be used to adjust popularity/trend information (e.g., via hatching, etc.) displayed to a user. For example, a user's profile may be used in combination with a search term in generating popularity/trend. Specifically, if the user's profile includes information that the user is a movie enthusiast, a query term that includes Kiefer Sutherland may be used in combination with the movie enthusiast information to adjust the popularity/trend information for the movie Lost Boys. Such matching of information to user-specific factors may provide a user with information that is not only trendy in general (i.e., has gross ratings figures or search activity that is increasing at a high rate) but is also trendy to the particular individual (i.e., increasing in popularity among people determined to have features that are similar to features of the requesting user).

Referring to FIG. 1A, there is shown a program guide system 100 that allows a user to search for media programming (e.g., broadcast television, cable television, satellite television, broadcast radio, satellite radio, and Internet media) by making a search request using a search page. The program guide system 100 presents, such as on a search results page (not shown) and/or on landing page 104, search results that are based on the search request. The system 100 also presents associated popularity/trend information to the user, for example, using hatching of individual program cells in a schedule grid 120.

The program guide system 100 may present the landing page 104, as shown in FIG. 1A, in response to a user selection of an item in a search result. The landing page 104 includes a search box 108 where a user may input a search term, such as a portion of a television program name, so as to generate an updated landing page responsive to the entered search term (i.e., with a new list of search results and with the grid 120 centered around the most relevant search result).

The landing page 104 includes media result groupings 116. The groupings 116 list one or more collections of programs related to a search term—here, the search term is “the tonight show.” The groupings 116 group collections of programs, for example, by program name, with each item in a grouping being a particular episode or airing of the program. Alternatively, the groupings 116 may be grouped using another parameter, such as grouping by the media channel presenting the programs, a genre of the programs, or the time of day the programs are presented. An additional results control 118 allows a user to navigate to other groupings that are not currently displayed, and that may be groupings considered to be less responsive to the user's request.

Each of the groupings 116 may also include a “more” control 158 that lists additional results within the particular grouping. In the pictured example, the three next-pending programs are shown for the media grouping associated with entry 156 for the television program “The Tonight Show”, and a user can select the “more” control 158 to show addition programs further in the future. Such a selection may cause the Tonight Show grouping to expand and may also cause the other groupings to be removed to make room for the expanded grouping.

The groupings can also include an “Add to my TV” control that, when selected, can add a particular program (such as a series of episodes) or episode to a personalized program guide for the user. For example, a “My TV” channel may be maintained for a user, as described below, and an episode or all the episodes of a program may be added to that channel when the “Add to My TV” control is selected.

The landing page 104 also includes the schedule grid 120. The schedule grid 120 is displayed adjacent to and side-by-side with the groupings 116. The schedule grid 120 presents programming for a particular geographic location. A user may specify or change his or her location by selecting a change location control 122 and by making an input, such as a postal code (e.g., a ZIP code) or city and state names. The selected location may also be used to determine the programs presented in the groupings 116. Where the user is a user registered with the system 100, the user's default location may be used to generate programming suggestions.

The schedule grid 120 presents media programming for a particular time range on a particular date, such as over several hours. A user may select the date using a calendar control 146, and the time use time bar 148. The calendar control 146 may default to a particular date, such as the current date. When a search is performed, the grid 120 may default to the area surrounding the time and channel of the episode determined to be a best search result. Selection of other episodes in the groupings 116 may cause the grid to move automatically to display programs around the selected episode (or the first-returned episode for a particular grouping, if a grouping is selected). In the pictured example, the grid 120 is enlarged from its normal size for clarity, so that the time divisions for the grid 120 do not match the time divisions for the calendar control 146. Typically, in an example like that shown, the calendar control 146 and time bar 148 would mate to the top of the schedule grid 120, and match time-wise the programming information displayed in the schedule grid 120.

The schedule grid 120 presents a list of media channels vertically along its left side, and times of day horizontally along its top side (which as mentioned, would generally match the time bar 148). The programs or episodes for a particular channel are presented in the channel's row and in a column having a time division closest to the actual time that the program is presented by its associated channel. The channels may be associated with a particular numerical channel for a broadcast, or may be a virtual channel such as a personalized channel or a stream of information over the internet.

The schedule grid 120 also includes a personalized channel 128, termed here as “My TV.” The personalized channel 128 includes controls that allow a user to create a virtual channel using content from actual channels or another personalized channel, such as the personalized channel of another user. Episodes or programs may be added to the personalized channel 128 in a variety of ways. For example, a user may select a program in the schedule grid 120, and may select a command to move it to the personalized channel 128 or may drag it to the personalized channel, among other things.

Also, one user may send a message to another user that identifies a particular program, such as by supplying a URL to an online video, supplying an episode ID number, or through another accepted mechanism. In addition, the user may select a control such as the “Add to My TV” control, where that control is associated with a program or episode.

The schedule grid 120 includes the personalized channel 128. The personalized channel 128 is presented near the top of the grid 120 and is slightly separated from the other channels to indicate that its programs are specified by the user rather than by a media provider. The personalized channel 128 can include multiple overlapping programs, and a user may be provided with various mechanisms with regard to watching and managing such programs. As one example, the programs may be displayed initially according to the times they are broadcast or are first made available for download. The user may then drag them later into time so that they do not overlap, so as to “program” a viewing schedule that the user may later follow. Where gaps exist in a schedule, a user's selection may be slid forward in time (if they have been previously broadcast and recorded) or the system may make selections for in-fill programming during the open period, such as by looking to other programs the user has selected, and providing similar programming that is similar to the selected programming. Such programming selected by the system may also include promotional programming such as commercials.

Programs that are shifted in time from their actual broadcast time may be recorded when they are broadcast, such as by a PVR, and may be displayed according to the program the user has established. In this manner, a user can easily select programs to view, see whether the selected programs can be viewed when they are broadcast, and view the programs in a selected order as if they were live programs, but by time-shifting the programs in some selected manner.

The schedule grid 120 has an associated jump control 150 and an associated filter control 152. The jump control 150 allows a user to quickly move to the current time and date in the grid 120 or to a primetime (e.g., 8:00 PM) for the current day. The filter control 152 can be used to filter out various parts of the grid. For example, the filter may be used to show only prime time or late night programming, so that, for example, the grid jumps from 11:00 PM directly to 8:00 PM the next day. Likewise, the filter can be used to show only channels in a particular category, such as only movies channels or sports channels, or channels specifically selected by a user as their “favorites” channels.

Referring to FIG. 1 A, the grid 120 includes a trends key 160 that can explain for the user the meaning of various styles of hatching used to indicate show popularities in the grid 120. Specifically, hatchings bar 162 shows the hatching styles arranged in ascending order by popularity. Particularly, hatching style 162a shows the hatching style used to indicated shows in the grid 120 with the highest popularity (e.g., very popular and/or ascending popularity). In contrast, hatching style 162b shows the hatching style used to indicate shows in the grid 120 with the lowest popularity (e.g., not as popular and/or with descending popularity). Other different styles of hatching can also be used, in ascending to descending order, in the hatchings bar 162. For example, varying colors or shades of color may be displayed and correlated with various levels of popularity. As such, a user viewing the grid 120 can use trends key 160 as a reference in gauging the popularity of individual cells in the grid 120 having the same hatching styles. As a result, the user can immediately see which programs are popular and/or are becoming popular, and can use such information to quickly select a program to watch.

For example, Tonight Show cell 166a is one popular cell having the hatching style 162a indicating that the corresponding show is very popular and/or rapidly ascending in popularity. In particular, Tonight Show cell 166a is included in the “My TV” personalized channel 128 that may, for example, include the user's favorite shows. As depicted, cell 166a is highlighted. The system 100 may also use highlighting, for example, to identify cells in the grid 120 that match the selected entry 156, which in this case is the top search result of the media result groupings 116. The cell 166a also matches the content and hatching style of the Tonight Show cell 166b showing on CBS. Other cells with the highest popularity (e.g., as indicated by hatching style 162a) are “24” cells 166c and 166d.

Similarly, cells 167a-167d are groups of shows with increasingly lower popularities, as indicated by the next four respective hatching styles 162. Finally, “Lost” cell 168 is the show with the lowest popularity, as indicated by shading that matches hatching style 162b.

As noted, the popularity may be both static (e.g., measuring current audience levels from the most recent episode or an average over episodes) or dynamic (e.g., measuring changes in audience participation or internet activity over time, such as over the prior few weeks). A user may be provided with a control (not shown) to control the level at which static or dynamic popularity play a role in determining the classification of a particular episode of a program. For example, a user may adjust a slider bar between dynamic and static popularity. For example, a leading-edge or “trendy” user may choose to have a system weight its ratings of programs heavily toward dynamic popularity so that they can quickly see emerging programs even before they become popular. In contrast, a more conservative viewer may weight the blending more toward static popularity, so that they are not directed toward a program until it has been “tested” by many viewers and has stood the test of time, so to speak.

FIG. 1B is an example screen shot showing a program guide arranged using popularity information. The guide is similar to that shown in FIG. 1A, but with the channels sorted by popularity. Specifically, rows of individual channels are generally sorted “higher” in the grid when one or more shows for that channel are more popular. In particular, to rate a channel's popularity, the system 100 uses popularity of the channel's shows during the time period depicted (e.g., 8:00 PM to 10:30 PM time slots). Although hatching like that shown in FIG. 1A is also shown here, such hatching could be eliminated because a user can determine popularity separately from hatching simply by looking to the order of the channels.

The particular popularity of a channel may relate only to the program that is currently showing, or may be a blend of the current program and future programs. The relevant importance of each program to the mix can decrease as the program is further in the future. Likewise, a program's contribution to a popularity score can decrease substantially if the program is substantially complete, and the next full program can dominate the weightings for generating a popularity score for a particular channel.

For example, channel “4” row 170a in the grid 120 includes Night Rider cell 172a which is shaded with the highest popularity hatching style 162a, and Cool Jams, which has average popularity. Similarly, channel “26” row 170b includes Movie of the Week cell 172b, also shaded with the highest popularity hatching style 162a, and a U2 concert of average popularity. The two upcoming programs of high popularity may dominate over the programs of average popularity because the latter programs are nearing completion. The two rows 170a and 170b are sorted “higher” in the grid 120 than channel “18” row 170c which includes Bad Karma cell 172c and World Fest cell 172d. The higher sorting can be based, for example, on the relatively lower popularity of cells 172c and 172d, each of which are shaded with the lowest popularity hatching style 162b.

In another example, channel “120” row 170d includes Dick Cavett cell 172e and Decent Show cell 172f. Cells 172e and 172f may correspond to shows having offsetting popularities. For example, while Decent Show cell 172f may be shaded with a hatching style indicating a somewhat ascending popularity, Dick Cavett cell 172e may be shaded with a hatching style indicating a somewhat descending popularity. In a sense, such popularities may offset each other, resulting in channel “120” row 170d being sorted somewhere in the middle of the grid 120 (e.g., not the most popular nor the least popular channel).

As such, the channels with the trendiest programs are sorted higher in the grid 120. The grid 120 depicted may be only part of a larger program grid. For example, a sliding bar 174 may be used to position the displayable portion of the grid 120 to various areas in the overall grid (e.g., all channels; not just the ones depicted). Specifically, the user may slide the sliding bar 174 up to the top of the trend arrow 176 to see the highest popularity shows, or to the bottom of the trend arrow 176 to see programs people like less.

The page 104 may also include a “Show MyTrends” control 176. The user may use such a control, for example, to show trend information in which the user is interested, such as to launch a display that graphically depicts popularity/trend information over time that correlates to the user's interests. The “Show MyTrends” control 176 may be a toggling control, in that its selection may cause trends directed at the user to be shown, and may cause the control 176 to be replaced with a “Show General Trends” control, whose selection will cause the system to again display programs according to general popularity data.

In some implementations, the user may be able to change how the grid 120 is sorted, for example, by specifying particular time slots to be sorted. For instance, if the user selects (e.g., by highlighting, clicking, etc.) the 9 PM time slot header, the system 100 may re-sort the grid 120 by popularity using the 9 PM time slot as the primary factor.

In some implementations, the user may be able to configure how sorting is performed on the grid 120. For example, using a popularity/trend settings screen (not shown) the user may be able to specify that channels with very popular shows are to be sorted higher (e.g., at the top of the list) regardless of how many unpopular shows exist (e.g., during the time slots displayed). In this way, unpopular shows will not offset popular ones, such as keeping them from being displayed near the top of the grid 120.

Other user controls may exist in relation to the grid 120. For example, a scroll bar or other such feature (not shown) may allow the user to see additional programs beyond the currently displayed time slots. Similarly, a user may be allowed to click on the grid and drag it in various directions to see additional programs at additional time slots. Such scrolling may occur, for example, without affecting the popularity-based sort order of the grid 120. Controls may also be used to scroll up and down within the grid 120.

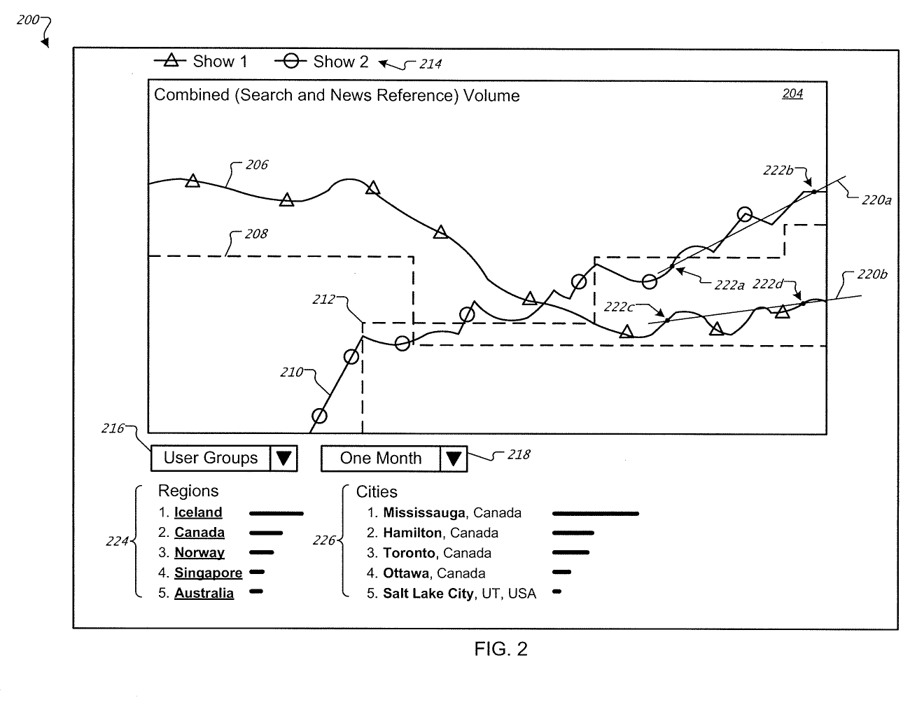

FIG. 2 shows a graph 200 showing trends between two media programs and a general correlation between two forms of audience preference data over time. Such a graph may be displayed, for example, if the user chooses to display popularity/trend data for two programs: a new program that is generally rising in popularity, and an established program that may be experiencing a significant loss in popularity. The particular display shown here can both be displayed to a user, and can represent data tracked by the systems and methods described in this document. The particular form of the output here is similar to output that has been provided for more than a year by the general Google Trends service (http://www.google.com/trends).

The graph 200 includes a graph display area 204 that graphically depicts the popularities of two shows (e.g., Shows 1 and 2) over time. The graph display area 204 includes popularity lines 206, 208, 210 and 212 for Shows 1 and 2. The lines 206-212 are drawn in reference to a vertical axis representing popularity, and a horizontal axis representing time. Line markings used to identify popularity lines 206-212 (e.g., as being associated to Shows 1 or 2) are explained in key 214. For instance, triangle markings located at intervals on the line 206 indicate that popularity line 206 corresponds to Show 1. In contrast, circle markings on line 210 indicate that popularity line 210 corresponds to Show 2.

In addition to line markings, line styles can be used to indicate the source of popularity information. For instance, the solid line style of lines 206 and 210 can signify the combined popularity score of user click-through data and search data continuously received over time. Dashed lines, such as lines 208 and 212, can represent audience preference data, such as data that is received each week corresponding the individual episodes of a particular program. As depicted, FIG. 2 may represent a time frame of three to four weeks, based on the number of discrete jumps upward (or downward) in audience popularity (e.g., for a weekly television program, or week-end box office “take” for a movie).

Popularity lines 206 and 208 represent a generally decreasing popularity of Show 1, while popularity lines 210 and 212 represent a generally increasing popularity of Show 2. For instance, based on the height of lines 206 and 208 relative to the time period depicted in area 204, Show 1 may be an established show that has recently been becoming less popular with audiences. By contrast, lines 210 and 212 begin from zero somewhat after the beginning of the time period depicted in area 204. As such, Show 2 may be a relatively new program that has generally increased in popularity since it first aired.

The graph 200 may include user controls, such as a user groups control 216 and time period control 218, or other controls for controlling the content and time period of graphs in the graph area 204. For example, the user groups control 216 may be a pull-down menu that allows the user to specify various specific types of users from which to base the graphs of trend/popularity data. For instance, various users may identify themselves to some online service (e.g., Google) as members of a group, such as members of Facebook.com or some other online group. A user may employ control 216 to see trend data based solely on those members by selecting particular groups. For example, if the user is young, the user may want to see only trend data from users of particular social networking sites (e.g., by selecting “MySpace.com” or other such option from control 216). Likewise, such group data may be used in computing a “Popular To Me” score for display of programming information to a user.

The time period control 218 can allow the user to specify a specific time period of interest for which popularity/trend data is desired. For example, by using the time period control 218, the user can control the time period displayed in the graph area 204. The time period control 218 may be, for instance, a pull-down menu, listing durations ranging from minutes or hours up to weeks, months or years. As depicted, the duration selected for time period control 218 is one month, and as such includes three to four discrete changes to audience data (e.g., corresponding to Shows 1 and 2 that may air weekly). Shorter time periods may show changes in popularity more quickly and more starkly, while longer time periods can permit a smoother view of popularity trends over time.

Trend slopes 220a and 220b represent the change in popularity over time for Shows 1 and 2, respectively. Specifically, trend slopes 220a and 220b are drawn along, and correspond to, segments of lines 206 and 210, representing user click-though data or other user events tracked over time. Trend slope 220a connects popularity points 222a and 222b, and trend slope 220b connects popularity points 222c and 222d. Other trend slopes (not shown) can be drawn along audience preference lines 208 and 212. Trend slope 220a can indicate the relative increase or decrease in popularity of its corresponding media program, such as the Show 1 popularity line 206. A steeper positive slope (e.g., rising from left-to-right) indicates a positive trending popularity, while a negative slope (e.g., falling from left-to-right) indicates a show that is becoming less popular. Such slopes (or other mathematical representations of trends) may be, for example, determined by simple linear regression analysis or other forms of statistical analysis.

Trend slopes may also depend heavily on the time period over which the line slopes are computed. For example, during the late spring, it may be expected that most television programs would be watched less and may be on a downward slope as people are moving into summer activities. In such situations, a more representative trend may be computed using, for example, a longer time period.

The graph 200 may include additional displays, such as regions ranking display 224 and cities ranking display 226, or other such information that may categorize the source of the data used for the graph area 204. For example, regions ranking display 224 may list the top several regions (e.g., based on user counts by country, etc.) that are responsible for the popularity of a particular program. Similarly, cities ranking display 226 may list the highest-ranking cities (e.g., based on user counts) that contribute to popularity/trend data. In both displays 224 and 226, bars of various lengths may be displayed adjacent to the region and city names to indicate relative media program popularities exhibited by users within those regions and cities.

In some implementations, the user may be able to change the appearance of the lines (e.g., lines 206-212) by clicking on specific region or city names in the displays 224 or 226. For example, by clicking on “Canada” in regions ranking display 224, lines 206-212 may be redrawn to display the popularity/trend information for just that region (e.g., Canada).

In general, the various data shown graphically in FIG. 2 may be accessed by a system for determining popularity of media programs. Such data may be available via a standard API, which an accessing system may provide with media-related terms and certain parameters (e.g., a time period for computing such popularity data). The accessing system may receive in return data about popularity of the submitted media-related term or terms, and may use such data to, for example, compute popularity scores for certain programs for presentation in various forms to a user, such as in the forms shown in FIGS. 1A and 1B.

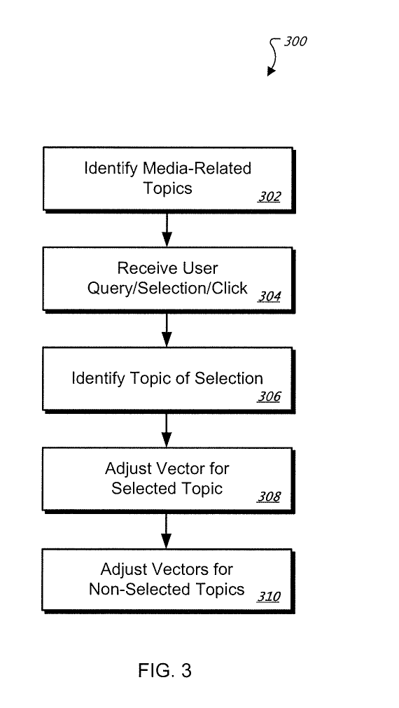

FIG. 3 is a flow chart of a process 300 for identifying trends in media information. In general, the process 300 shows what happens during the steady-state operation of the system 100 over time when users (e.g., users on the Internet) submit queries, and make selections or clicks on the result sets of those queries, and as news story information rolls in. As these user-related events occur, they are associated with particular media programs or topics, the topic associations are logged, and vectors are generated to determine what kind of trend is occurring for those programs or topics. For example, referring to FIG. 2, the system can generate trends such as the trend represented by trend slope 220a. Specifically, the trend slope 220a can indicate the relative popularity trend of the corresponding media program represented by popularity line 206. Alternatively, a connection to particular media-related topics and the generation of trend information may be delayed until a particular request has been made for the data.

At box 302, the system identifies media-related topics. For instance, the topics identified can correspond to TV shows, movies, etc., and the attributes of each. Attributes may include, for example, show/movie/media titles, key words, actor/personality names, genre information, time slot information, demographics, or any information related to media programming. For example, referring to FIG. 1A, the attributes may be associated with media programs such as the TV programs identified in the media result groupings 116 on landing page 104. Moreover, the attributes are typically known by the system before such groupings 116 are displayed, such as resulting from a user query for particular shows matching search terms.

At box 304, the system receives a user query, selection, or click. For example, referring to FIG. 1A, a user may enter a search query (e.g., “the tonight show”) in search box 108. As a result, media programming responsive to the search can be displayed in the media result groupings 116. The user may select or click on an entry in the media result groupings 116, such as entry 156 for the television program “The Tonight Show.” The user may further select the “more” control 158 to show addition programs further in the future. The system may associate such selections with an identifier for the user, such as a session ID or a cookie, so that multiple actions of a user may be used, such as to find commonalties between selections by that user and selections by other users, such as in a collaborative filtering approach to processing the data.

At box 306, the system identifies the topic(s) of the user's selection. For example, if the user selects entry 156 for the television program “The Tonight Show,” such topic(s) identified can include the show title, host names (e.g., Jay Leno), guest names (e.g., Kiefer Sutherland), the program's genre (e.g., talk show), and the like.

At box 308, the system adjusts the vector for the selected topic(s). Specifically, the vector that is adjusted corresponds to the topic(s) of the media program that the user has queried, selected or clicked. In particular, the vector is adjusted to indicate an increased popularity of the corresponding topic(s) resulting from the interest shown by the user. For example, if the user clicks on entry 156 for “The Tonight Show,” vectors may be updated for the corresponding topics (e.g., “The Tonight Show, Jay Leno, Kiefer Sutherland, and talk shows in general). The system may make such adjustments simply by registering a selection of the particular topic or topics, such that such selections may later be added together. The registered selection may also be correlated to a time stamp so as to permit later determinations of the timing of selections.

At box 310, the system adjusts vectors for non-selected topics. For example, for any entry in the media result groupings 116 that the user does not select, vectors for any corresponding topics can be adjusted to indicate a decreased popularity. For instance, if a different talk show (e.g., Tyra Banks) appears in the groupings 116, but the user does not select that show, the vectors for corresponding topics (e.g., show name Tyra Banks) can be adjusted to indicate general unpopularity.

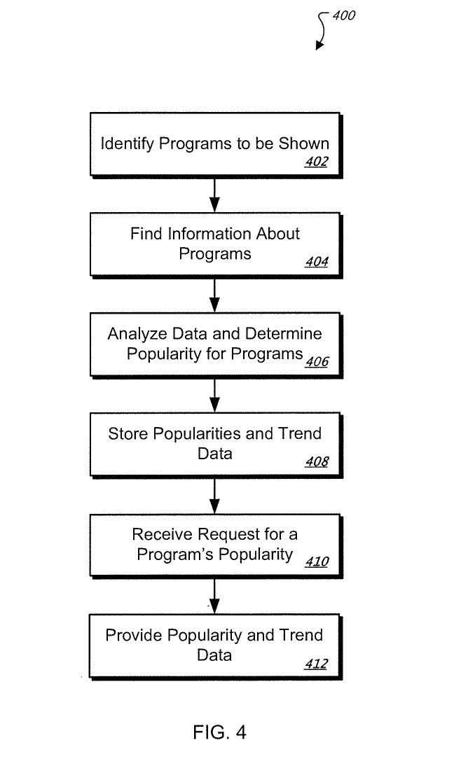

FIG. 4 is a flow chart of a process 400 for associating media programs with popularity data. Generally, the process 400 is more of batch process by which the data such as Google Trends data is harvested (e.g., by Google) to create a smaller data set that is related specifically to particular media topics, and to the popularity or trends in those topics.

At box 402, the system identifies programs to be shown. Specifically, the programs may be all programs that are going to be shown on television over the next two or four weeks or some other time. For example, referring to FIG. 1A, the programs may be the types of media programming that the user may see in the media result groupings 116 or in the individual cells in the schedule grid 120.

At box 404, the system finds information about the programs. Program information may be available, for example, from structured databases or sources such as the Internet Movie Database (IMDb) or other similar databases for various types of media (e.g., television, etc.). By accessing these databases, keywords can be located that are associated with the programs. The keywords may then be used to query popularity- and trend-related data. In some implementations, such queries could be run in the background (e.g., on top of the existing Google Trends system). In addition, the identity of programs airing during particular periods may also be identified.

At box 406, the data is analyzed to determine the popularity of programs. The analysis may occur in various ways, such as averaging popularity or trend data for various terms associated with the program, or using weighted averages. For example, the title of the program (e.g., The Tonight Show) may be given the greatest weight, and searches on main characters (e.g., host Jay Leno or guest Kiefer Sutherland) in the program may be given lesser weight. In addition, a determination may be made about how unique the title is in the English language so that it may be given more or less weight to indicate the likelihood that its title is representative of the program in the search results. For example, the phrase “king of queens” is very likely to be related to the television program of the same name, where is the term “lost” is much less likely to be so related. As such, for the program “Lost,” actor names or character names (e.g., John Locke), may be given greater weight than the name of the program itself.

At box 408, the popularity and trend data is stored. The data may be stored so that it can be accessed easily, such as from a flat file database or other suitable data file. For example, all of the trend or popularity data associated with a particular program may be processed (or “crunched”) to produce a single pair of trend and popularity numbers that are normalized in some manner. The numbers can then be stored, for example, in a simple look-up table using standard IDs for particular programs or episodes of the program. This look-up table can then be stored with a front end and a media serving system, or the table could even be stored on a user's remote device, because of its simplicity.

At box 410, the system receives a request for a program's popularity. For example, referring to FIG. 1A, the request may occur when the user selects an entry in the media result groupings 116 or the individual cells in the schedule grid 120. The request may include the program name or some other request that Google, through a one-box system, identifies as the program. The request may also come from a grid builder program that is producing a program guide grid, such as grid 120. The grid builder may identify programs from available schedule data, and submit the ID for each program in the table.

At box 412, the system provides popularity and trend data. For example, using the program IDs submitted by the grid builder, the system can return a popularity score in general, and more specifically, a trend score, for each ID. The grid builder may then use these scores to affect the display of the program or programs. Referring to FIG. 1A, such scores may be used, for example, to generate the various trend-based hatching styles in cells 166a-d, 167a-d and 168.

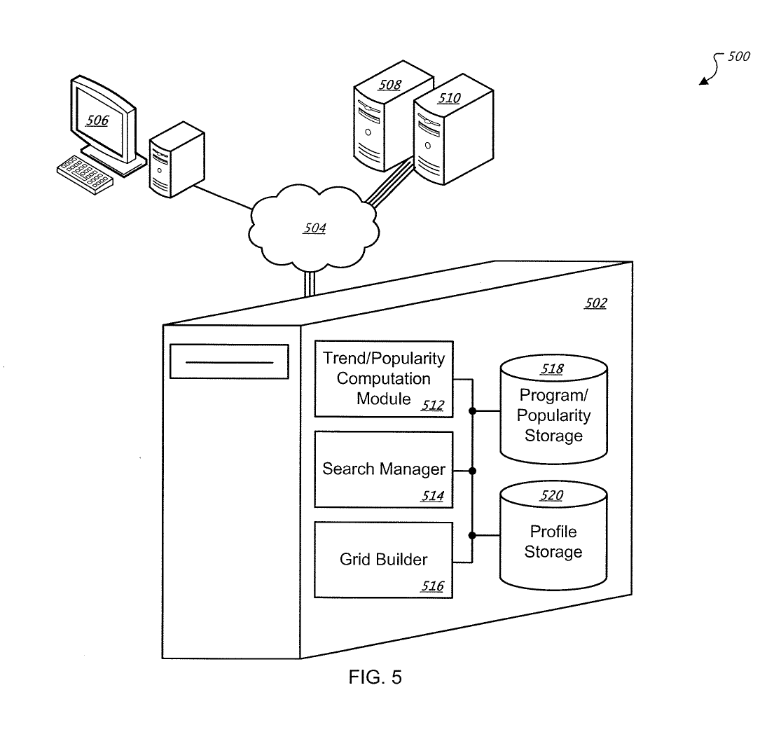

FIG. 5 is schematic diagram of a system 500 for providing media-related popularity information. The information can be provided, for example, by a media results server 502 to a user's computer 506 via a network 504 (e.g., the Internet).

The system 500 includes two rack servers: a user click server 508 that keeps track of user click data, and a search server 510 that is associated with, and may be logically coupled to, a search engine. Each of these servers 508 and 510 may, for example, be maintained by an Internet search service, such as Google, or associated services, such as Google Trends.

The media results server 502 includes a trend/popularity computation module 512, a search manager 514, and a grid builder 516. The trend/popularity computation module 512 accesses the user click server 508 and search server 510 to determine the popularity of various terms. In one example, the trend/popularity computation module 512 may be essentially similar to the current Google Trends system. The search manager 514 can receive media-related requests, which may be determined to be media-related requests by the search engine 510. For example, referring to FIG. 1A, such requests may occur when a user enters a search query in search box 108 on a media-related web page. The grid builder 516 can produce a programming guide grid or other mechanisms for outputting programming or media related content. For example, the grid builder may produce the program guide grid 120.

The media results server 502 also includes two storage entities 518 and 520 (e.g., databases) that serve the modules 512-516. The program/popularity storage 518 basically receives inputs from the module 512 relating to the popularity of programs. For example, the storage 518 may store popularity/trend data for any of several specific programs, or for episodes of those programs. Such storage may simply consist of, for example, the look-up table discussed above that provides a correlation between a program ID and one or more popularity ratings that have been normalized to some value.

The profile storage 520 stores information about the user, such as user profile information. Such information may, for example, rely on a cookies that identify the user. The use of user profile information can allow the popularity data to be customized for the user, in effect providing a “trendy for you” or “trendy to me” type of feature. The personalization may occur on various levels, such as customizing the popularity data based on the user's interests, occupation, or other personal attributes that may be stored, for example, in the user's user profile. Of course, such personalization may require additional storage for various levels of trend data that relate to various forms of personalization.

For example, where there is a relatively small number of personalizations (e.g., under 100), such as corresponding to various groups of people (e.g., SciFi lovers, environmentalists, old school comedy lovers, etc.), a group of tables can be formed, such as one table for each group. In another example, where the data is to match a complex personal profile, the data may have to be generated in real time. Specifically, the real-time generation of trend and other popularity in response to personal profile information may use concepts such as collaborative filtering. In particular, collaborative filtering may be used to determine other users who have made searches similar to the present user, who have viewing habits similar to the current user, or who have profile information similar to that of the current user. For instance, similar viewing habits may be judged by data associated with media programs the users have dragged into their personal channels, such as personalized “My TV” channel 128. The system can then analyze the searches performed by these similar users to make determinations of popularity for particular upcoming programs.

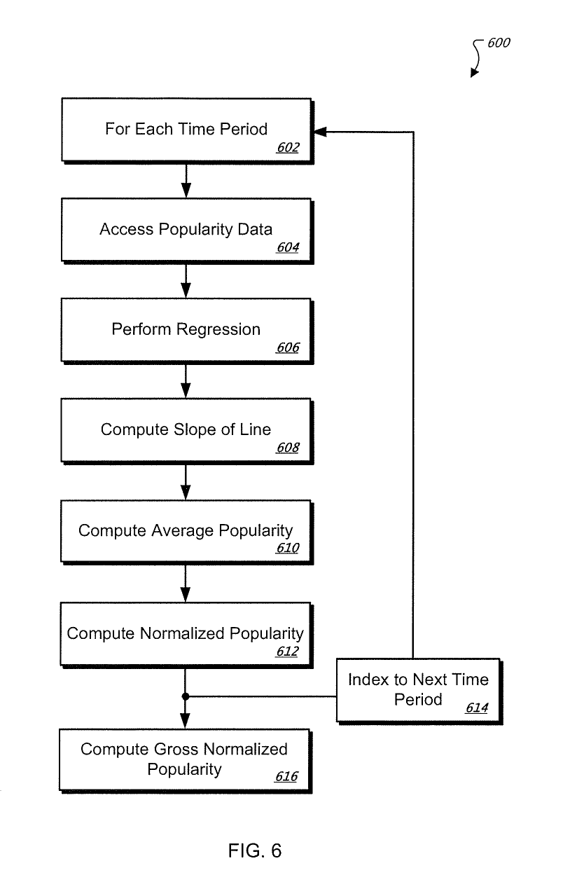

FIG. 6 is a flow chart of a process 600 for computing popularity data for multiple media programs and multiple time periods. The process 600 is similar to the process 300 depicted in FIG. 3, but the process 600 deals with multiple time periods. Specifically, using the process 600, a user can “tune” his or her request to get popularity data for longer or shorter time frames, depending on the user's needs. For example, the user may view popularity and trend information for a specific program or topic, such as on the graph 200 of FIG. 2. If the trend information displayed to the user is not adequate, such as if trend slope 220a is thought not to represent the program's true trend, the user may decide to change the time period used to compute the trend. The process 600 can facilitate such user requests to change time periods in this way.

In other examples, a user may simply want the latest hot thing and would use a one week or one month time frame, or the user may want to see which programs are generally getting better as the season progresses, and thus may take a one-year period. Various search controls may automatically select a particular time period too, such as assuming that typical users want a one-month period.

In some implementations, the system may analyze the results, looking for inaccurate or misleading data. In one example, as described above, Spring-time ratings and user click data may not be a very good indicator of television popularity because people are generally less interested in television in the Spring—regardless of whether they like a particular program or not. The system may detect such correlations and automatically adjust to take only the data that does not have such correlations. Alternatively, the system may adjust beforehand by knowing not to take Spring-only TV data, but instead to use a longer time period such as October to February.

At box 602, the system selects the time period. The time period selected may be one of several time periods associated with a program for which popularity trends can be computed. For example, the time period selected may be the last week of July (e.g., of the current year), the entire month of July, or any time period for which popularity data may be accessed.

At box 604, the popularity data for the selected time period is accessed. For example, if the time period is the last week of July, 2007, popularity data for seven days of July 25-31 is accessed.

At step 606, regression is performed. Specifically, the popularity data accessed at box 604 is analyzed for popularity. The popularity data may be from various sources, and each source's data may be weighted differently. In addition, the system may automatically adjust popularity data for the time of year, such as to offset any effects of audience cycles, spring ratings, etc. As a result of this step, popularity numbers may be calculated or otherwise obtained for the end points of the time period selected at box 602. For example, such end points used in performing regression may correspond to intermediate points along a popularity line, such as popularity points 222a and 222b on FIG. 2.

At box 608, the slope of the line is calculated. For example, the slope can be calculated using the popularities calculated in box 606 for the end points of the selected time period. In a sense, the slope indicates the popularity trend, and may be shown graphically, such as with the trend slopes 220a and 220b in FIG. 2. If a particular slope is positive, the trend is an upward trend in popularity, and as such, the corresponding program is considered to be rising in user/audience popularity. If a particular slope is negative, the corresponding program is losing its user/audience appeal.

At box 610, the average popularity is computed. For example, the system may simply take the mean of the end point popularities of a program to calculate its average popularity. In other implementations, the average may be weighted to assign higher weights to more recent portions of the time period. At box 612, the normalized popularity is computed. For example, the system may combine the average popularity is computed at box 610 with other previously computed popularities. In a sense, a normalized popularity can be thought of as a subtotal.

At box 614, the index to the next time period is obtained. For example, if the process 600 has just computed a normalized popularity for the last week in July, the next time period may correspond to the entire month of July. The processing of boxes 602 through 612 can then be repeated for the next time period (e.g., all of July). In some implementations, if a time period selected in box 614 includes previously processed time periods, boxes 602 though 612 may in some way use the results of the smaller time periods included in the longer one.

At box 618, the gross normalized popularity is computed. Specifically, the gross normalized popularity may be thought of as the grand total of all popularity and trend numbers computed for a media program—perhaps weighted more heavily for particular time periods. As such, a gross normalized popularity may be a single set of numbers for the popularity and popularity trend that may be stored, for example, in a quick look-up table.

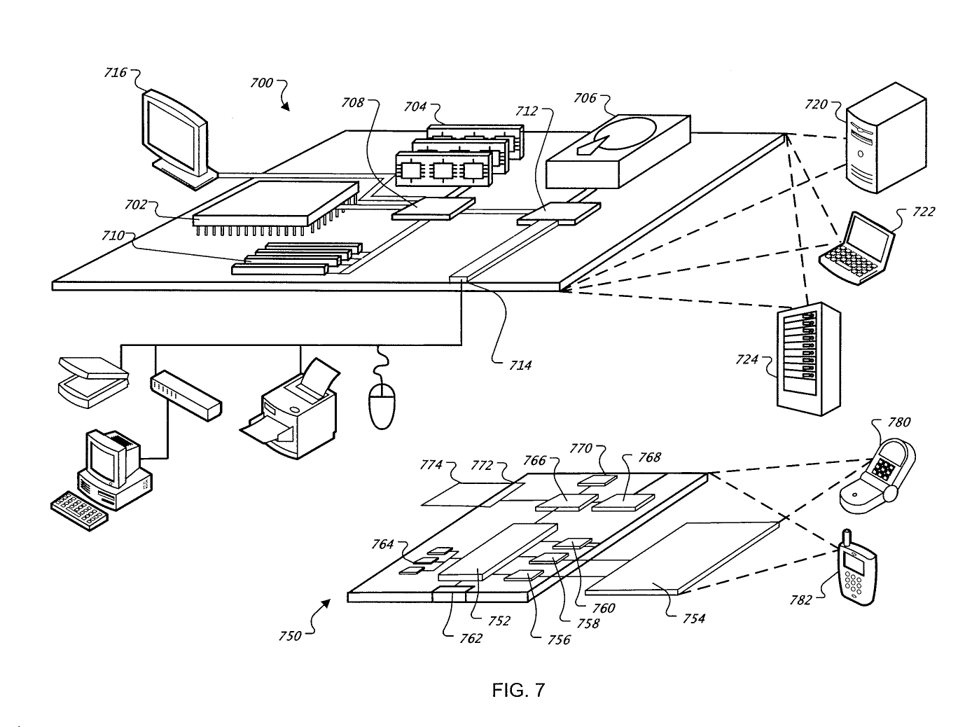

FIG. 7 shows an example of a computer device 700 and a mobile computer device 750 that can be used to implement the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, memory on processor 702, or a propagated signal.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

A number of embodiments have been described. Nevertheless, it will be understood that various modifications may be made without departing from the spirit and scope of what has been described here. Accordingly, other embodiments are within the scope of the following claims.

1. A computer-implemented method, comprising:
receiving, by a computer system, a request for a display of media-related information;
obtaining, by the computer system, information indicative of popularity for a plurality of media programs that are responsive to the received request, and correlating the information indicative of popularity with a particular time of year that corresponds to a current date;
generating, using the information indicative of popularity for the plurality of media programs correlated with the particular time of year, trend data that indicates changes in popularity for particular ones of the plurality of media programs during the particular time of year, the trend data being generated by (i) obtaining profile information for a user that is associated with the request, and (ii) blending one or more portions of the information indicative of popularity correlated with the particular time of year, according to one or more user preference; and
displaying, by the computer system, the plurality of media programs in an electronic program guide with a display that indicates values of the trend data.

2. The computer-implemented method of claim 1, wherein the request relates to a predetermined time period over which the plurality of media programs are available for viewing.

3. The computer-implemented method of claim 1, wherein generating the trend data further includes combining popularity data over time to generate a blended popularity for display to a user.

4. The computer-implemented method of claim 1, wherein the information indicative of popularity comprises internet search activity data or news story information.

5. The computer-implemented method of claim 1, wherein the information indicative of popularity comprises media ratings data.

6. The computer-implemented method of claim 1, wherein the electronic program guide comprises a two dimensional programming grid.

7. The computer-implemented method of claim 6, further comprising displaying popularity of the plurality of media programs through background representations in cells of the two dimensional programming grid.

8. The computer-implemented method of claim 1, further comprising sorting channels in the electronic program guide in order of popularity.

9. The computer-implemented method of claim 1, wherein the request for the display of media-related information is generated by a selection of a hyperlink representing an episode of a media program.

10. The computer-implemented method of claim 1, further comprising receiving a search request, providing media-related search results in response to the search request, and receiving the request for the display of media-related information by selection of a portion of the search results.

11. A computer-implemented system, comprising:
non-transitory memory storing data relating to popularity of one or more media programs correlated with a particular time of year that corresponds to a current date;
an interface configured to receive media-related requests and match the requests to the data relating to popularity of the one or more media programs; and
a programming guide builder executable on a computer system to generate code for constructing a programming guide containing programs responsive to the media related requests, generating, using the data relating to popularity correlated with the particular time of year, trend data that indicates changes in popularity for particular ones of the one or more media programs during the particular time of year, the trend data being generated by (i) obtaining profile information for a user that is associated with the media related requests, and (ii) blending one or more portions of data relating to popularity correlated with the particular time of year, according to user preferences, and displaying popularity indications for the one or more media programs in the guide.

12. The computer-implemented system of claim 11, wherein the data relating to popularity includes trend data for the one or more media programs that indicates trends over time in popularity of the one or more media programs.

13. The computer-implemented system of claim 11, wherein the received media-related requests relate to a predetermined time period over which the one or more media programs are available for viewing.

14. The computer-implemented system of claim 11, wherein the data is correlated to information indicative of popularity that comprises trend data that represent trends over time of popularity of one or more media programs.

15. The computer-implemented system of claim 11, wherein the data is correlated to information indicative of popularity that comprises internet search activity data or news story information.

16. The computer-implemented system of claim 11, wherein the data is correlated to information indicative of popularity that comprises media ratings data.

17. The computer-implemented system of claim 11, wherein the program guide builder is programmed to sort channels in an electronic program guide in order of popularity.

18. One or more tangible non-transitory computer-readable storage media storing instructions that, when executed, perform actions comprising:
receiving, by a computer system, a request for a display of media-related information;
obtaining, by the computer system, information indicative of popularity for a plurality of media programs that are responsive to the received request, and correlating the information indicative of popularity with a particular time of year that corresponds to a current date;
generating, using the information indicative of popularity for the plurality of media programs correlated with the particular time of year, trend data that indicates changes in popularity for particular ones of the plurality of media programs during the particular time of year, the trend data being generated by (i) obtaining profile information for a user that is associated with the request, and (ii) blending one or more portions of the information indicative of popularity correlated with the particular time of year, according to one or more user preferences; and
displaying, by the computer system, the plurality of media programs in an electronic program guide with a display that indicates values of the trend data.

19. The computer-readable storage media of claim 18, wherein generating the trend data further includes combining popularity data over time to generate a blended popularity for display to a user.

20. The computer-readable storage media of claim 18, wherein the information indicative of popularity comprises internet search activity data or news story information.
